(19) United States
(12) Patent Application Publication
(10) Pub. No.: US 2025/0139584 A1
(43) Pub. Date: May 1, 2025

(54) Interactive Web-Based Workforce Management System Assisted with Artificial Intelligence

(71) Applicant: Clarkson Aerospace Corp., Houston, TX (US)

(72) Inventors: Llayron Clarkson, Houston, TX (US); Soumya Vinod, Houston, TX (US); Julian Pierre, Houston, TX (US); Axit Garcia, San Antonio, TX (US); Jace Foulk, Houston, TX (US)

(21) Appl. No.: 18/927,601

(22) Filed: Oct. 25, 2024

Related U.S. Application Data
(60) Provisional application No. 63/593,733, filed on Oct. 27, 2023.

(51) Int. Cl. G06Q 10/1053; G06F 16/21; G06F 16/2455; G06Q 10/0631

(52) U.S. Cl. CPC G06Q 10/1053; G06F 16/211; G06F 16/2455; G06Q 10/063112

(57) ABSTRACT

Managing a workforce database includes obtaining a set of non-standardized records each associated with a candidate, wherein the set of non-standardized records are obtained from multiple sources. A formatting schema is applied to the set of non-standardized records to obtain standardized records, and the standardized records are stored in a data structure. The data structure associates the standardized records with a mapping functionality in accordance with data within the non-standardized records associated with a location. The data structure is accessible via an interactive user interface.

### BACKGROUND

Workforce database management is the process of collecting, storing, analyzing and using data related to the human resources of organizations. It can help to optimize the recruitment, retention, performance, and development of employees. However, workforce database management also faces some challenges, such as ensuring data quality, security and privacy, integrating data from different sources and systems, and aligning data with recruitment strategy and culture.

With shortage of skilled personnel in multiple fields, identifying talent and talent management have become major issues for organizations. The search process for right candidates and organizing them based on skillsets, geographic location, and the like can be an arduous task. Databases with consolidated information and user-friendly interface are not readily available.

### BRIEF DESCRIPTION OF THE DRAWINGS

FIG. 1 shows, in block diagram form, a simplified network diagram for providing workforce management, according to one or more embodiments.

FIG. 2 shows a flowchart of a technique for generating a workforce database in accordance with one or more embodiments.

FIG. 3 shows a flowchart of a technique for generating candidate results in accordance with one or more embodiments.

FIG. 4 shows a simplified system diagram of devices connected across a network, in accordance with one or more embodiments.

### DETAILED DESCRIPTION

This disclosure pertains to systems, methods, and computer readable media for providing workforce management. In particular, embodiments described herein relate to a dynamic interactive web-based database that allows identifying candidates based on geographic location, skillsets, educational institution and other requirements of interest to hiring organizations. The need for an individual to organize large amounts of data is minimized based on how data entry is formatted, and through the use of Al, the data can be structured and organized almost automatically. The interactive database will allow institutions to be easily selected from the map that provides a list of candidates available with their respective details. The search process can be narrowed down based on specific criteria categorizing the candidates and finding the right match based on the search queries provided by the user.

According to one or more embodiments, techniques described herein relate to populating a workforce management database by collecting non-standardized candidate records from multiple sources and applying a formatting logic to standardize the records for organization into a candidate data store. In some embodiments, the formatting logic includes applying non-standardized candidate records to a model trained to standardize the records for a candidate record data store. For example, the non-standardized data may be reformatted to fit a standard set of data categories. The model may be trained on un-standardized data to recognize data from the various categories and reformat the un-standardized data accordingly.

Once the standardized data is stored in a candidate data store, a user interface (UI) can be provided by which the data is accessible. In some embodiments, the UI may be a web-based UI which provides functionality to query the candidate data store and present results. According to one or more embodiments, the UI may include functionality to access location information related to records resulting from a query and map the location information on a graphical map presented along with the query results.

The embodiments described herein provide a technical improvement for generating a data structure comprising non-standardized records by efficiently determining a corrected format of the data and organizing the data accordingly. By consolidating data from the non-standardized records into the data structure reduces the number of requests by the workforce management database for non-standardized records stored in a remote server housing the non-standardized records. Furthermore, by storing the non-standardized records in the data structure in a unified format can directly reduce the number of operations performed by a processor executing instructions to fetch data from the data structure. For example, when a processor fetches non-standardized records of disparate formats, the instructions executed by the processor to fetch the non-standardized records are not uniform which can result in computational inefficiencies when requesting the non-standardized records. When the data, from the non-standardized records, is stored in a uniform data structure format, the processor can execute the same instructions to fetch the data structure each time the workforce management database requests a record associated with any candidate. Because the instructions executed by the processor are the same each time the workforce management database requests a record associated with a candidate, efficiencies in compute can be realized. In doing so, compute and other resources are preserved.

Further, embodiments described herein provide a technical solution for presentation of geographically linked query results by tying candidate records to mapping information for presentation in a user interface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In some embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of entity resolution having the benefit of this disclosure.

As used herein, the term “computer system” can refer to a single programmable device or a plurality of programmable devices working together to perform the function described as being performed on or by the computer system.

As used herein, the term “medium” refers to a single physical medium or a plurality of media that together store what is described as being stored on the medium.

As used herein, the term “network device” can refer to any programmable device that is capable of communicating with another programmable device across any type of network.

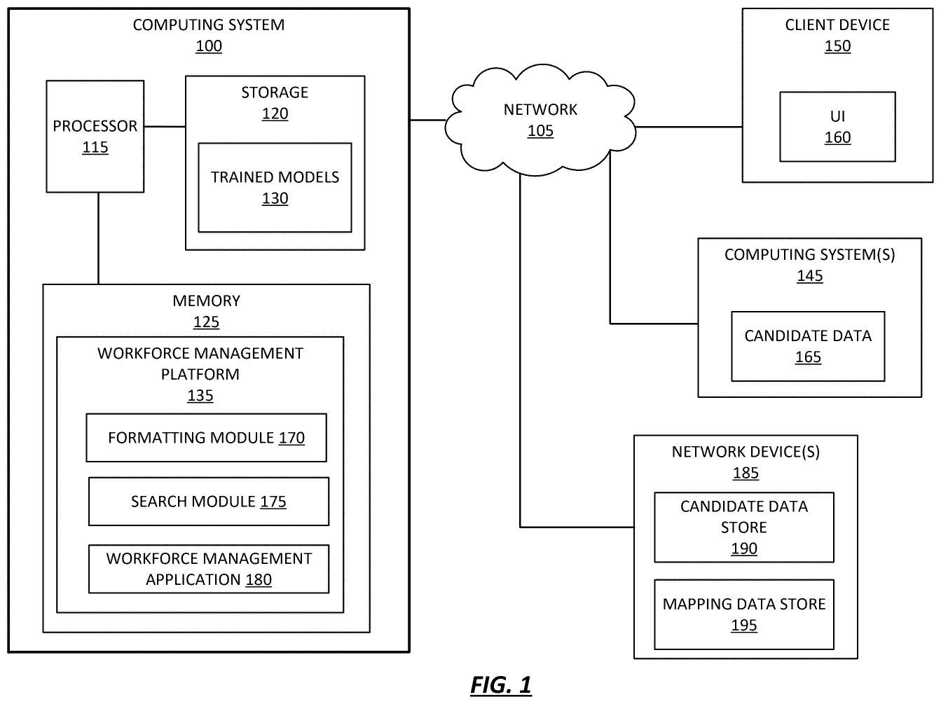

Turning to FIG. 1 a system diagram is presented illustrating a distributed system for an enhanced workforce management process, according to one or more embodiments. FIG. 1 includes a computing system 100 configured to manage a workforce data store, connected to one or more network devices 185 and other devices such as client device 150 and/or computing system(s) 165 across a network 105. Computing system 100 may be, for example, one or more server devices or other computing devices. Further, computing system 100 may be a distributed network system, such as a network cloud, across which the various components and functionality described within computing system 100 are distributed. Computing system(s) 145 may include any kind of device accessible across network 105, with which computing system 100 may communicate, and which may provide relevant candidate data 165. For example, computing device(s) 145 may include additional computing system, a server, a remote computer, or the like. Further, computing device(s) 145 may be controlled by the same or different entity as computing system 100 and/or client device 150. For example, computing system(s) 145 may include multiple computing devices associated with different institutions or organizations to which the candidates belong. Network 105 may include many different types of computer networks available today, such as the Internet, a corporate network, a Local Area Network (LAN), or a personal network, such as those over a Bluetooth connection. Each of these networks can contain wired or wireless programmable devices and operate using any number of network protocols (e.g., TCP/IP). Network 105 may be connected to gateways and routers, servers, and end user computers.

According to one or more embodiments, computing system 100 may include, for example, a storage 120, a memory 125 and processor 115. Processor 115 may include a single processor or multiple processors. Further, in one or more embodiment, processor 115 may include different kinds of processors, such as a central processing unit (“CPU”) and a graphics processing unit (“GPU”). Memory 125 may include a number of software or firmware modules executable by processor 115. Memory 125 may include a single memory device or multiple memory devices. As depicted, memory 125 may include a workforce management platform 135. The workforce management platform 135 may provide functionality for intelligently and automatically generating candidate data for storage in local storage 120, or remotely, for example in cloud storage in network device(s) 185 as candidate data store 190. Storage 120 may include a single storage device, or multiple storage devices. Candidate data store 190 may include any kind of data structure which intelligently stores records of candidates in a standardized format. Candidate data store 190 may therefore be stored in a variety of formats, such as spreadsheets, databases, tables, or any other data structure.

The workforce management platform 135 may include multiple functional modules, which may be provided to clients (e.g., client device 150) in any combination. The workforce management platform 135 may include a formatting module 170, a search module 175, and workforce management application 180. The formatting module 170 may utilize artificial intelligence, for example in the form of neural architecture in the form of a trained model to ingest non-standardized candidate records and produce standardized candidate records. The trained network may be stored, for example, as part of trained models 130 in storage 120. The search module 175 may enable functionality for receiving a search query and providing results based on standardized candidate records, from example from candidate data store 190. In some embodiments, the search module 175 may access and provide additional information to improve the contextual presentation of the data. For example, based on geographical location information recorded in or derived from a standardized candidate record, the search module 175 may provide mapping data, for example from mapping data store 195 for presentation along with the data related to the resulting standardized candidate record. According to one or more embodiments, the mapping data may be tied to cloud-based mapping platform which is configured to provide a visual indication of a location of data based on location information.

The workforce management platform 1 may additionally include a workforce management application 180 which may be used by a user at computing system 100, or accessed remotely, for example by a user at client device 150 via user interface 160. The workforce management application 180 may receive candidate data 165 in the form of non-standardized records from computing system(s) 145 and use the various modules to generate the candidate data store 190, as well as provide the functionality for the user interface 160 from which the candidate data can be retrieved.

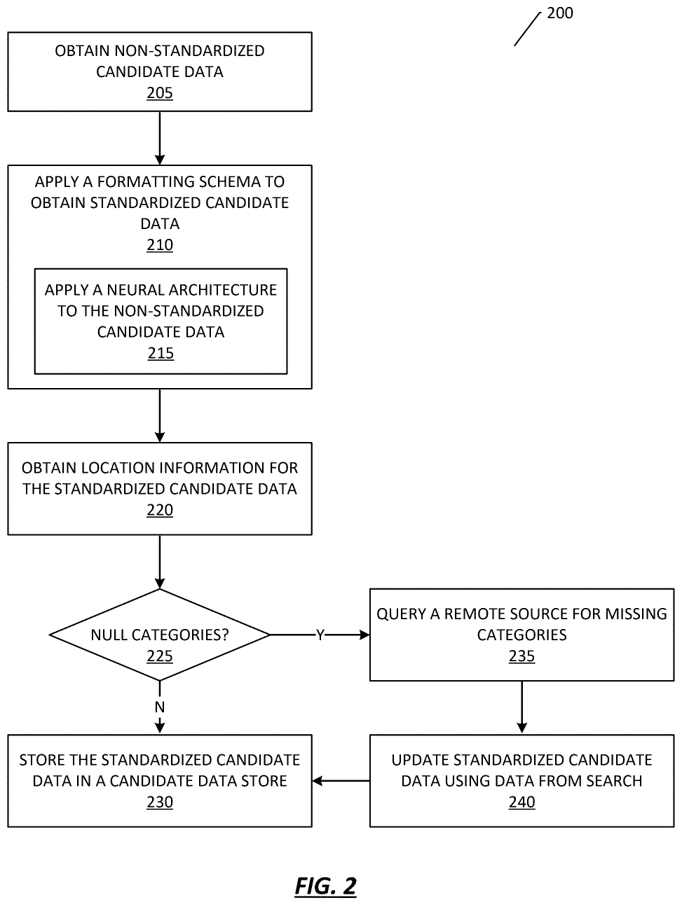

FIG. 2 shows a flowchart of a technique for generating a workforce database in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 200 begins at block 205, where non-standardized candidate data is obtained. The non-standardized candidate data can be obtained from a variety of sources and in a variety of formats. The non-standardized candidate data may include data in various categories or classifications such as name, associated institution, education background such as degree or field of study, location, skillset, and the like. According to one or more embodiment, the non-standardized candidate data may be received individually, for example from candidates, or in bulk, such as from affiliated institutions as a set of candidate records.

The flowchart 200 continues to block 210, where the system applies a formatting schema to the non-standardized data in order to obtain standardized candidate data. In some embodiment, the formatting schema may be an automated logic which categorizes and/or enhances the data in the non-standardized candidate data to match the expected formatting for a candidate data structure. For example, the candidate data structure may store global candidate records in a predefined data structure with particular categories of data. These categories may include, for example, name, affiliated institution, education background, honorifics, skillset, field of study, and the like.

In some embodiments, applying the formatting schema to the non-standardized candidate data involves applying a neural architecture to the non-standardized candidate data to obtain standardized candidate data that conforms to a candidate data structure. The neural architecture may include a trained neural network configured to categorize and/or enhance the data in the non-standardized candidate data to format the non-standardized data to conform to the formatting for a candidate data structure. According to one or more embodiments, the neural architecture may be a neural network or other artificial intelligence architecture that is trained on standardized candidate data which has been formatted for a particular candidate data store based on a predefined set of categories. Additionally, or alternatively, the neural network may be trained based on non-standardized data along with corresponding standardized data such that the neural network is trained to detect a mapping between components of non-standardized data and a particular standardized data format. As a result, the neural network, once trained, can ingest non-standardized data and predict or generate a candidate record in a standardized format for a particular candidate data structure.

The flowchart 200 continues to block 220 where location information for the standardized candidate information is obtained. The location information may be obtained or derived from the non-standardized or standardized dat. For example, the non-standardized data may include location information as to the current location, residence, or the like, of the candidate and/or an entity associated with the candidate, such as an affiliated institution. Thus, the location information may include address information, city information, or the like. In addition, the location information may be derived based on the candidate record by performing a lookup for location information based on the candidate data, such as the candidate, the affiliated institution, or the like.

In some embodiments, the workforce management application may further be configured to enhance or augment candidate data received in the form of non-standardized candidate data with additional data intelligently collected to better conform the received non-standardized candidate data. Thus, a block 225 a determination is made as to whether any of the categories of the standardized candidate records are null. If no categories of the standardized record are null, then the flowchart 200 concludes at block 230, where the standardized candidate data is stored in the candidate data store. As described above, the candidate data store may be in the form of any data structure which holds the standardized candidate data in a format which can be queried and provided as results of a search in a user interface.

Returning to block 225, if a determination is made that the standardized candidate records include one or more null records for a particular classification of candidate data, then the flowchart proceeds to block 235. At block 235, one or more remote sources are queried for the missing categories of the candidate records. For example, the workforce management application 180 may query a network device having additional data regarding the particular candidate or candidates for which data is missing in the standardized records. As an example, if a field of study is missing, then a query may be performed among a remote data set to determine the candidate field of study, such as records from the affiliated institution, social networks such as LinkedIn, or the like. As another example, if location data is missing, a mapping platform may be queried to identify location data associated with the candidate, or other entity associated with the candidate, such as affiliated institution or the like.

The flowchart 200 proceeds to block 240, where the standardized candidate records are updated based on the results of the query performed at block 235. As such, if the query for the missing data is successful, then the null field may be filled with the acquired data to further enhance the standardized candidate record.

The flowchart 200 concludes at block 230, where the standardized candidate data is stored in the candidate data store. As described above, the candidate data store may be in the form of any data structure which holds the standardized candidate data in a format which can be queried and provided as results of a search in a user interface.

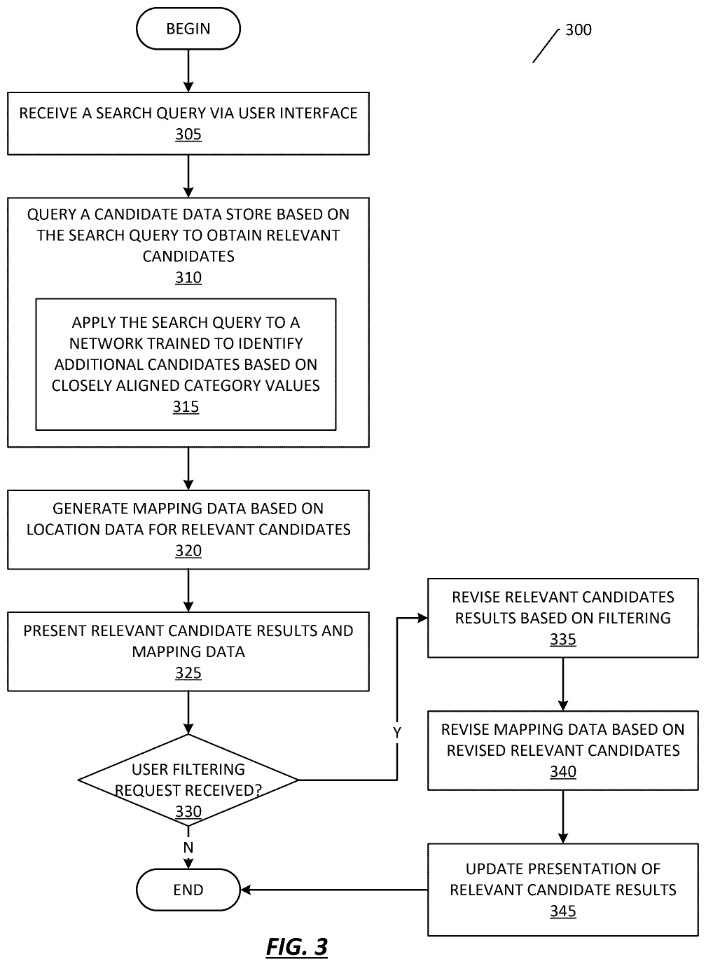

FIG. 3 shows a flowchart of a technique for generating candidate results in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 300 begins at block 305, where a search query is received via a user interface. According to one or more embodiments, the workforce management application 180 may be accessed at an end user device via a web portal or the like. The workforce management application 180 may include a user interface in which a user may request a view of a subset of the relevant candidate data in accordance with an input query. The user interface may include one or more user input components by which a user may enter a query. These user input components may include, for example, text boxes, check boxes, radio buttons, drop down menus, or the like. In some embodiments, the drop-down menus may include nested menus by which a user can select among broader categories, and then more narrow categories. As an example, a drop-down menu may be used to select among different broad areas of study, such as Engineering, Science, Arts, and the like. Upon selection, a corresponding subset of menu items may be selected, such as, for Engineering, Mechanical Engineering, Civil Engineering, Aerospace Engineering, Chemical Engineering, Electrical Engineering, and the like. Additionally, or alternatively, a nested selection component may be included for other fields, such as location. As an example, a set of regions may be provided as selectable components in a nested menu, such as Northeast, Southeast, Pacific Northwest, Midwest, and the like. Upon selection, a second tier of corresponding selectable components can be provided, such as a set of states, cities, affiliated institutions, or the like.

The flowchart 300 continues at block 310, where the candidate data store is queried to obtain relevant candidates. In some embodiments, the workforce management application 180 may perform the search among the candidate data store to identify relevant candidates. In some embodiments, the search may be performed using heuristics determined based on the search query, such as text entered by the user and/or other user selections among user input components.

In some embodiments, querying the candidate data store at block 310 includes, at block 315, applying the search query to a network trained to identify additional relevant candidates based on closely aligned category values. For example, a neural network, may be trained on data indicating qualified candidates for queries having certain skill sets. The neural network may be trained to detect closely aligned categories based on the training data. For example, skills that may not match a particular query, but often arise in candidates determined to be matches for a query having the queried skillset may be identified by the trained neural network. Thus, in addition to candidates having a requested skillset, the workforce management application may identify candidates having alternative skillsets which are closely aligned to the requested skillset.

The flowchart 300 proceeds to block 320, where mapping data is generated based on location data for the relevant candidates. According to one or more embodiments, location data may be identified within the result candidate records. Additionally, or alternatively, one or more categories of data in the candidate record can be identified as locatable on a mapping service. For example, a third-party mapping service may be able to locate a particular institution indicated as an affiliated institution in the candidate record. As such, the location information may be determined, in part, based on a query to a third-party service.

At block 325, the relevant candidates are presented along with the mapping data. According to one or more embodiments, the relevant candidates can be presented in a graphical user interface configured to provide a visual indication of matching candidates in a manner that optimizes the display of data by providing relevant candidate records, along with a graphical indication of a map indicating a graphical representation of location information for the matching candidates. According to one or more embodiments, the relevant candidate records may be provided, for example, in the form of a table, a listing, a drop-down menu, or the like. In some embodiments, the presentation of the candidate record may include metadata related to the location which allows for a dynamic view of a particular candidate or candidates on the graphical representation of the map. As an example, as a user selects or hovers over a particular name, the location information related to that user may be highlighted on the map.

The flowchart 300 continues to block 330, where a determination is made as to whether any additional filtering requests are received from a user. For example, the relevant candidate records and/or location information may be presented in a selectable, sortable, and/or filterable manner such that the candidate records are associated with user input components. These user input components may be configured to receive user input or instruction to modify a presentation of the format of the relevant candidates, or to modify a presentation of the relevant candidates shown. If no additional filtering requests, or other input requests for modifying the presentation of the relevant candidates are received, then the flowchart 300 concludes.

Returning to block 330, if additional filtering requests are received from a user, then the flowchart 300 proceeds to block 335, where the relevant candidate data is revised based on the filtering or other modification instruction. For example, the user input components may be used to receive user input or instruction to modify a presentation of the format of the relevant candidates, or to modify a presentation of the relevant candidates shown. In some embodiments, this may include acquiring additional relevant candidate records to those previously captured from the candidate record store.

At block 340, mapping data is revised based on the revised relevant candidates. According to one or more embodiments, the mapping interface may be provided by a third-party service. To that end, the filtered data or revised data may be transmitted in the form of a revised query to obtain additional or supplemental location information. As another example, the modifications to the mapping presentation may be performed by the workforce management application 180 without querying a third-party service. The flowchart 300 concludes at block 345, where the presentation of the relevant candidate results is updated based on the revisions to the relevant candidates.

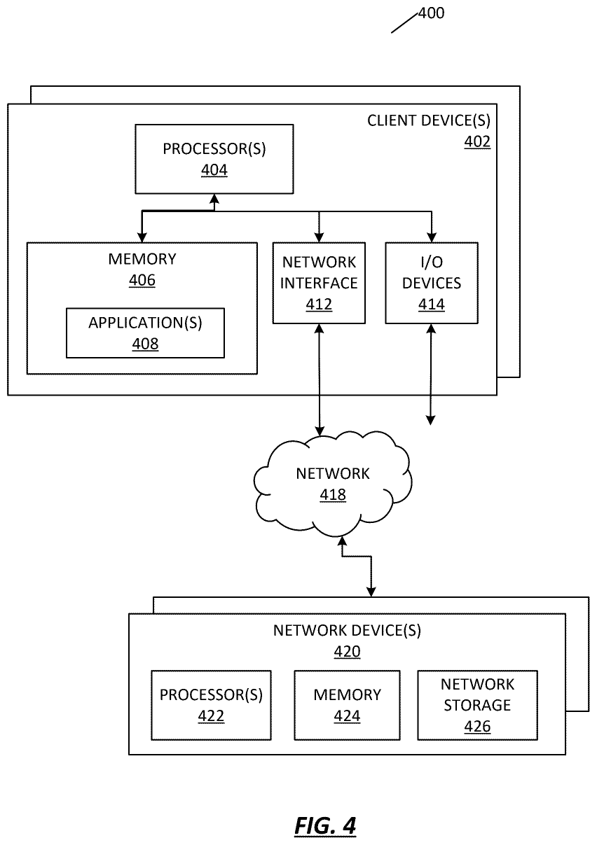

FIG. 4 shows an example of a hardware system for implementation of the workforce management system in accordance with the disclosed embodiments. FIG. 4 depicts a network diagram 400 including a client computing device 402 connected to one or more network devices 420 over a network 418. Client device 402 may comprise a personal computer, a tablet device, a smart phone, network device, or any other electronic device which may be used to perform workforce management on a computer program. The network 418 may comprise one or more wired or wireless networks, wide area networks, local area networks, enterprise networks, short range networks, and the like. The client computing device 402 can communicate with the one or more network devices 420 using various communication-based technologies, such as Wi-Fi, Bluetooth, cable connections, satellite, and the like. Users of the client devices 402 can interact with the network devices 420 to access services controlled and/or provided by the network devices 420.

Client devices 402 may include one or more processors 404. Processor 404 may include multiple processors of the same or different type, and may be configured to execute computer code or computer instructions, for example computer readable code stored within memory 406. For example, the one or more processors 404 may include one or more of a central processing unit (CPU), graphics processing unit (GPU), or other specialized processing hardware. In addition, each of the one or more processors may include one or more processing cores. Client devices 402 may also include a memory 406. Memory 406 may each include one or more different types of memory, which may be used for performing functions in conjunction with processor 404. In addition, memory 406 can include one or more of transitory and/or non-transitory computer readable media. For example, memory 406 may include cache, ROM, RAM, or any kind of computer readable storage device capable of storing computer readable code. Memory 406 may store various programming modules and applications 408 for execution by processor 404. Examples of memory 406 include magnetic disks, optical media such as CD-ROMs and digital video disks (DVDs), or semiconductor memory devices.

Computing device 402 also includes a network interface 412 and I/O devices 414. The network interface 412 may be configured to allow data to be exchanged between computing devices 402 and/or other devices coupled across the network 418. The network interface 412 may support communication via wired or wireless data networks. Input/output devices 414 may include one or more display devices, keyboards, keypads, touchpads, mice, scanning devices, voice or optical recognition devices, or any other devices suitable for entering or retrieving data by one or more client devices 402.

Network devices 420 may include similar components and functionality as those described in client devices 402. Network devices 420 may include, for example, one or more servers, network storage devices, additional client devices, and the like. Specifically, network device may include a memory 424, storage 426, and/or one or more processors 422. The one or more processors 422 can include, for example, one or more of a central processing unit (CPU), graphics processing unit (GPU), or other specialized processing hardware. In addition, each of the one or more processors may include one or more processing cores. Each of memory 424 and storage 426 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A non-transitory computer readable medium comprising computer readable code executable by one or more processors to:
obtain a set of non-standardized records each associated with a candidate, wherein the set of non-standardized records are obtained from a plurality of sources;
apply a formatting schema to the set of non-standardized records to obtain standardized records; and
store the standardized records in a data structure,
wherein the data structure associates the standardized records with a mapping functionality in accordance with data within the non-standardized records associated with a location.

2. The non-transitory computer readable medium of claim 1, wherein the computer readable code to apply the formatting schema to the set of non-standardized records comprises computer readable code to:
apply the non-standardized records to a model trained to format the non-standardized records into a format associated with the data structure.

3. The non-transitory computer readable medium of claim 1, wherein the non-standardized records comprise at least classification of data from a set of classifications of data comprising a name, an associated institution, a degree name, and a skillset.

4. The non-transitory computer readable medium of claim 1, further comprising computer readable code to:
provide a user interface comprising one or more user input components configured to receive user input comprising a search query; and
in response to receiving the search query via the user interface, provide a results interface comprising:
a listing of relevant candidates based on the standardized records associated with the relevant candidates; and
a graphical map indicating the location for each of the relevant candidates in accordance with the standardized records associated with the relevant candidates.

5. The non-transitory computer readable medium of claim 4, further comprising computer readable code to:
determine a requested skillset from the search query; and
apply the requested skillset and the non-standardized records to a model trained to identify additional relevant candidates for which standardized records comprise alternative skillsets closely aligned to the requested skillset.

6. The non-transitory computer readable medium of claim 4, wherein the graphical map comprises one or more selectable components which, when selected, cause the results interface to update in accordance with the selected component.

7. The non-transitory computer readable medium of claim 1, wherein the computer readable code to apply the formatting schema to the set of non-standardized records comprises computer readable code to:
identify, for a particular standardized record, a null category; and
request, from a remote device, data for the null category.

8. A system comprising:
one or more processors; and
one or more computer readable media comprising computer readable code executable by the one or more processors to:
obtain a set of non-standardized records each associated with a candidate, wherein the set of non-standardized records are obtained from a plurality of sources;
apply a formatting schema to the set of non-standardized records to obtain standardized records; and
store the standardized records in a data structure,
wherein the data structure associates the standardized records with a mapping functionality in accordance with data within the non-standardized records associated with a location.

9. The system of claim 8, wherein the computer readable code to apply the formatting schema to the set of non-standardized records comprises computer readable code to:
apply the non-standardized records to a model trained to format the non-standardized records into a format associated with the data structure.

10. The system of claim 8, wherein the non-standardized records comprise at least classification of data from a set of classifications of data comprising a name, an associated institution, a degree name, and a skillset.

11. The system of claim 8, further comprising computer readable code to:
provide a user interface comprising one or more user input components configured to receive user input comprising a search query; and
in response to receiving the search query via the user interface, provide a results interface comprising:
a listing of relevant candidates based on the standardized records associated with the relevant candidates; and
a graphical map indicating the location for each of the relevant candidates in accordance with the standardized records associated with the relevant candidates.

12. The system of claim 11, further comprising computer readable code to:
determine a requested skillset from the search query; and
apply the requested skillset and the non-standardized records to a model trained to identify additional relevant candidates for which standardized records comprise alternative skillsets closely aligned to the requested skillset.

13. The system of claim 11, wherein the graphical map comprises one or more selectable components which, when selected, cause the results interface to update in accordance with the selected component.

14. The system of claim 8, wherein the computer readable code to apply the formatting schema to the set of non-standardized records comprises computer readable code to:
identify, for a particular standardized record, a null category; and
request, from a remote device, data for the null category.

15. A method comprising:
obtaining a set of non-standardized records each associated with a candidate, wherein the set of non-standardized records are obtained from a plurality of sources;
applying a formatting schema to the set of non-standardized records to obtain standardized records; and
storing the standardized records in a data structure,
wherein the data structure associates the standardized records with a mapping functionality in accordance with data within the non-standardized records associated with a location.

16. The method of claim 15, wherein applying the formatting schema to the set of non-standardized records comprises:
applying the non-standardized records to a model trained to format the non-standardized records into a format associated with the data structure.

17. The method of claim 15, wherein the non-standardized records comprise at least classification of data from a set of classifications of data comprising a name, an associated institution, a degree name, and a skillset.

18. The method of claim 15, further comprising:
providing a user interface comprising one or more user input components configured to receive user input comprising a search query; and
in response to receiving the search query via the user interface, providing a results interface comprising:
a listing of relevant candidates based on the standardized records associated with the relevant candidates; and
a graphical map indicating the location for each of the relevant candidates in accordance with the standardized records associated with the relevant candidates.

19. The method of claim 18, further comprising:
determining a requested skillset from the search query; and
applying the requested skillset and the non-standardized records to a model trained to identify additional relevant candidates for which standardized records comprise alternative skillsets closely aligned to the requested skillset.

20. The method of claim 18, wherein the graphical map comprises one or more selectable components which, when selected, cause the results interface to update in accordance with the selected component.
